(19) United States
(12) Patent Application Publication
(10) Pub. No.: US 2014/0055061 A1
(43) Pub. Date: Feb. 27, 2014

(54) Battery Powered Control Device For Driving A Load With A Pulse Width Modulated Signal

(71) Applicant: LUTRON ELECTRONICS CO., INC., Coopersburg, PA (US)

(72) Inventors: Samuel F. Chambers, Gwynedd Valley, PA (US); Peter W. Ogden, Jr., Breinigsville, PA (US); Jonathan L. Roe, Coopersburg, PA (US); Chenming Wu, Emmaus, PA (US)

(73) Assignee: LUTRON ELECTRONICS CO., INC., Coopersburg, PA (US)

(21) Appl. No.: 13/832,343

(22) Filed: Mar. 15, 2013

Related U.S. Application Data
(60) Provisional application No. 61/692,969, filed on Aug. 24, 2012.

(51) Int. Cl. H02P 7/00; H05B 33/08; H05B 37/02

(52) U.S. Cl. CPC H02P 7/00; H05B 37/02; H05B 33/0842
USPC 318/139; 323/351; 315/209 R

(57) ABSTRACT

A battery-powered load control device (e.g., a motorized window treatment) is able to supply a pulse-width modulated current to an electrical load (e.g., a motor) while conducting a substantially DC battery current from a battery powering the motorized window treatment. The motorized window treatment includes a motor drive circuit for driving the motor with a pulse-width modulated signal to adjust the rotational speed of the motor, such that the motor conducts the pulse-with modulated current. The motorized window treatment also has an input circuit coupled between the battery and the H-bridge drive circuit. The input circuit has an output for conducting the pulse-width modulated load current, and conducts the substantially DC battery current from the battery. The input circuit may comprise, for example, a passive filter circuit (such as an inductor-capacitor filter) or an active circuit (such as a power converter).

### CROSS-REFERENCE TO RELATED APPLICATIONS

This application is a non-provisional application of commonly-assigned U.S. Provisional Application No. 61/692,969, filed Aug. 24, 2012, entitled BATTERY-POWERED MOTORIZED WINDOW TREATMENT, the entire disclosure of which is hereby incorporated by reference.

### BACKGROUND OF THE INVENTION

1. Field of the Invention

The present invention relates to a load control device for controlling the power delivered to an electrical load, and more specifically, to a battery-powered motorized window treatment having a motor drive circuit for driving a motor with a pulse-width modulated (PWM) signal.

2. Description of the Related Art

Motorized window treatments typically include a flexible fabric or other means for covering a window in order to block or limit the daylight entering a space and to provide privacy. The motorized window treatments may comprise roller shades, cellular shades, Roman shades, Venentian blinds, and draperies. The motorized window treatments include a motor drive for movement of the fabric in front of the window to control the amount of the window that is covered by the fabric. For example, a motorized roller shade includes a flexible shade fabric wound onto an elongated roller tube with an electronic drive unit installed in the roller tube. The electronic drive unit includes a motor, such as a direct-current (DC) motor, which is operable to rotate the roller tube upon being energized by a DC voltage.

Prior art electronic drive units are typically powered directly from an AC mains line voltage (e.g., 120 VAC) or from a low-voltage DC voltage (e.g., approximately 24 VDC) provided by an external transformer. Unfortunately, this requires that electrical wires to be run from the power source to the electronic drive unit. Running additional AC main line voltage wiring to the electronic drive unit can be very expensive, due to the cost of the additional electrical wiring as well as the cost of installation. Typically, installing new AC main line voltage wiring requires a licensed electrician to perform the work. In addition, if the pre-existing wiring runs behind a fixed ceiling or wall (e.g., one comprising plaster or expensive hardwood), the electrician may need to breach the ceiling or wall to install the new electrical wiring, which will thus require subsequent repair. In some installations where low voltage (e.g., from a low-voltage DC transformer) is used to the power the electronic drive unit, the electrical wires have been mounted on an external surface of a wall or ceiling between the electronic drive unit and the transformer, which is plugged into an electrical receptacle. However, this sort of installation requires the permanent use of one of the outlets of the electrical receptacle and is aesthetically unpleasing due to the external electrical wires.

Therefore, some prior art motorized window treatments have been battery powered, such that the motorized window treatments may be installed without requiring any additional wiring. Examples of prior art battery-powered motorized window treatments are described in greater detail in U.S. Pat. No. 5,883,480, issued Mar. 16, 1999, entitled WINDOW COVERING WITH HEAD RAIL-MOUNTED ACTUATOR; U.S. Pat. No. 5,990,646, issued Nov. 23, 2009, entitled REMOTELY-CONTROLLED BATTERY POWERED-WINDOW COVERING HAVING POWER SAVING RECEIVER; and U.S. Pat. No. 7,389,806, issued Jun. 24, 2008, entitled MOTORIZED WINDOW SHADE SYSTEM.

Battery-powered motorized window treatments typically comprise DC motors, which may be driven by a DC voltage to rotate the motor. The DC voltage provided to the motor may be pulse-width modulated to control the rotational speed at which the motor rotates. As a result, the motor may draw a pulse-width modulated current from the batteries of the motorized window treatment. It has been discovered that drawing a pulse-width modulated current with high peak currents from a battery may increase the equivalent series resistance (ESR) of the battery over time, and thus, decrease the usable capacity of the battery. Thus, there is a need for a battery-powered motorized window treatment that is able to control the rotational speed of the motor and has longer battery life than prior art motorized window treatments.

### SUMMARY OF THE INVENTION

As described hererin, a battery-powered control device for controlling an electrical load may comprise: (1) at least one battery for generating a battery voltage; (2) a load control circuit coupled to the electrical load for conducting a pulse-width modulated load current through the electrical load; and (3) an input circuit coupled between the battery and the load control circuit and having an output for conducting the pulse-width modulated load current, where the input circuit is operable to conduct a substantially DC battery current from the battery. The input circuit may comprise, for example, a passive filter circuit or an active circuit, such as a power converter.

Further, a battery-powered motorized window treatment may comprise at least one battery for generating a battery voltage, a motor, an H-bridge drive circuit for driving the motor, and a controller operatively coupled to the H-bridge drive circuit for driving the motor with a pulse-width modulated signal, such that the H-bridge drive circuit conducts a pulse-width modulated load current through the motor. The controller may be operable to adjust the duty cycle of the pulse-width modulated signal to adjust the rotational speed of the motor. The motorized window treatment may comprise an input circuit coupled between the battery and the H-bridge drive circuit and having an output for conducting the pulse-width modulated load current, where the input circuit is operable to conduct a substantially DC battery current from the battery. The motorized window treatment may further comprise a covering material, wherein rotations of the motor result in movements of the covering material.

Other features and advantages of the present invention will become apparent from the following description of the invention that refers to the accompanying drawings.

### BRIEF DESCRIPTION OF THE DRAWINGS

FIG. 1 is a perspective view of a motorized window treatment system having a battery-powered motorized window treatment and a remote control according to an embodiment of the present invention.

FIG. 2 is a perspective view of the battery-powered motorized window treatment of FIG. 1 in a full-opened position.

FIG. 3 is a front view of the battery-powered motorized window treatment of FIG. 1.

FIG. 4 is a simplified block diagram of a motor drive unit of the battery-powered motorized window treatment of FIG. 1.

FIG. 5 shows example waveforms illustrating the operation of the motorized window treatment of FIG. 1.

FIG. 6 is a simplified schematic diagram of a portion of the motor drive unit of FIG. 1 showing an input circuit and an H-bridge motor drive circuit in greater detail.

### DETAILED DESCRIPTION OF THE INVENTION

The foregoing summary, as well as the following detailed description of the preferred embodiments, is better understood when read in conjunction with the appended drawings. For the purposes of illustrating the invention, there is shown in the drawings an embodiment that is presently preferred, in which like numerals represent similar parts throughout the several views of the drawings, it being understood, however, that the invention is not limited to the specific methods and instrumentalities disclosed.

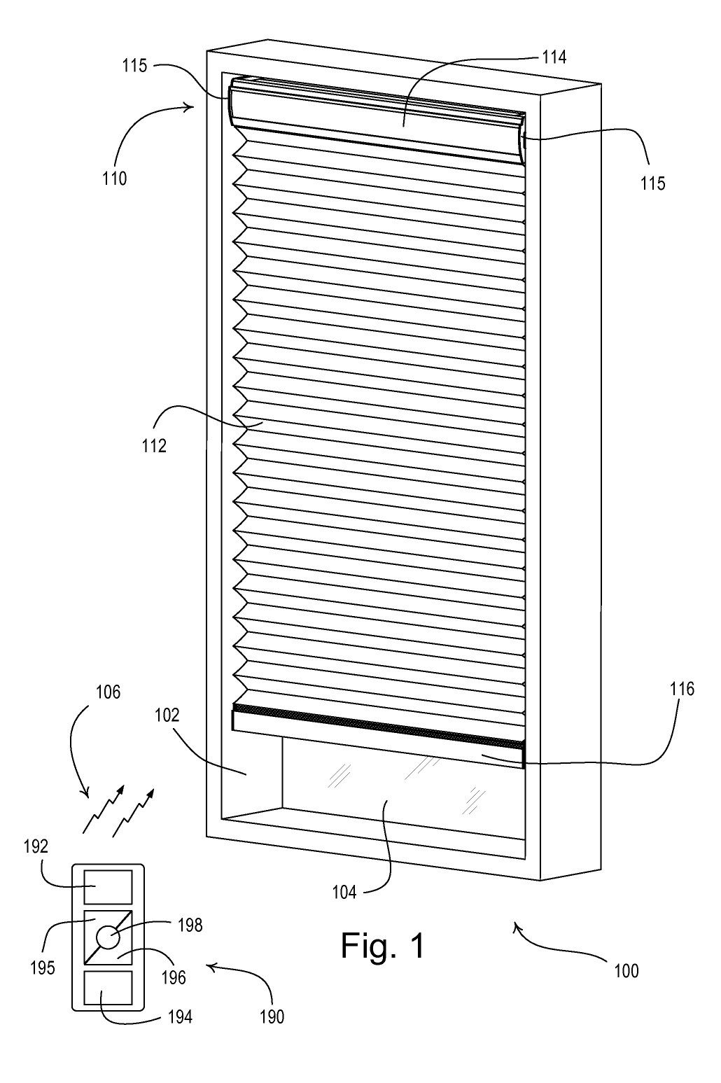

FIG. 1 is a perspective view of a motorized window treatment system 100 having a battery-powered motorized window treatment 110 mounted in an opening 102, for example, in front of a window 104. The battery-powered motorized window treatment 110 comprises a covering material, for example, a cellular shade fabric 112 as shown in FIG. 1. The cellular shade fabric 112 has a top end connected to a headrail 114 (that extends between two mounting plates 115) and a bottom end connected to a weighting element 116. The mounting plates 115 may be connected to the sides of the opening 102 as shown in FIG. 1, such that the cellular shade fabric 112 is able to hang in front of the window 104, and may be adjusted between a fully-open position P_{FULLY-OPEN} and a fully-closed position P_{FULLY-CLOSED} to control the amount of daylight entering a room or space.

The battery-powered motorized window treatment 110 could alternatively comprise other types of covering materials, such as, for example, a plurality of horizontally-extending slats (i.e., a Venetian or Persian blind system), pleated blinds, a roller shade fabric, or a Roman shade fabric. An example of a battery-powered motorized cellular shade is described in greater detail in commonly-assigned U.S. patent application Ser. No. 13/415,084, filed Mar. 8, 2012, entitled MOTORIZED WINDOW TREATMENT, the entire disclosure of which is hereby incorporated by reference. A battery-powered motorized roller shade (not shown) may comprise a covering material windingly received around a roller tube that may rotatably coupled to a motor of a battery-powered motor drive unit for raising and lowering the covering material. An example of a battery-powered motorized roller shade is described in greater detail in commonly-assigned U.S. patent application Ser. No. 13/768,587, filed Feb. 15, 2013, entitled MOTORIZED WINDOW TREATMENT HAVING A SERVICE POSITION, the entire disclosure of which is hereby incorporated by reference

The motorized window treatment system 100 comprises a wireless remote control, e.g., a radio-frequency (RF) remote control 190, for transmitting wireless signals, e.g., RF signals 106, to the motorized window treatment 110 to thus for control the operation of the motorized window treatment. Specifically, the RF remote control 190 is operable to transmit digital messages including commands to control the motorized window treatment 710 via the RF signals 106 in response to actuations of a plurality of buttons, e.g., an open button 192, a close button 194, a raise button 195, a lower button 196, and a preset button 198. The motorized window treatment 110 controls the cellular shade fabric 112 to the fully-open position P_{FULLY-OPEN} and the fully-closed position P_{FULLY-CLOSED} in response to actuations of the open button 192 and the close button 194 of the remote control 190, respectively. The motorized window treatment 110 raises and lowers the cellular shade fabric 112 in response to actuations of the raise button 195 and the lower button 196, respectively. The motorized window treatment 110 controls the cellular shade fabric 112 to a preset position P_{PRESET} in response to actuations of the preset button 198. Alternatively, the window treatment system 100 could comprise an infrared (IR) remote control (not shown) for transmitting IR signals to the motorized window treatment 110 to thus for control the operation of the motorized window treatment.

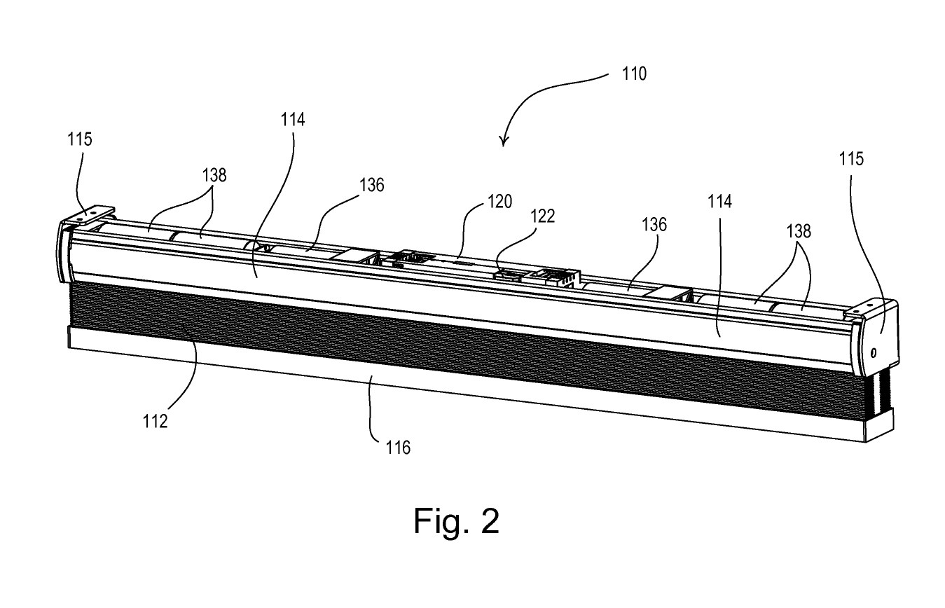

FIG. 2 is a perspective view of the battery-powered motorized window treatment 110 with the cellular shade fabric 112 in the fully-open position P_{FULLY-OPEN}. The motorized window treatment 110 comprises a motor drive unit 120 for raising and lowering the weighting element 116 and the cellular shade fabric 112 between the fully-open position P_{FULLY-OPEN} and the fully-closed position P_{FULLY-CLOSED}. By controlling the amount of the window 104 covered by the cellular shade fabric 112, the motorized window treatment 110 is able to control the amount of daylight entering the room. The motor drive unit 120 comprises an actuator 122, which is positioned adjacent the internal side 122 of the headrail 114 may may be actuated when a user is configuring the motorized window treatment 110. The motor drive unit 120 is operable to determine a target position P_{TARGET} for the weighting element 116 in response to commands included in the RF signals 106 received from the remote control 190 and to subsequently control a present position P_{PRES} of the weighting element to the target position P_{TARGET}.

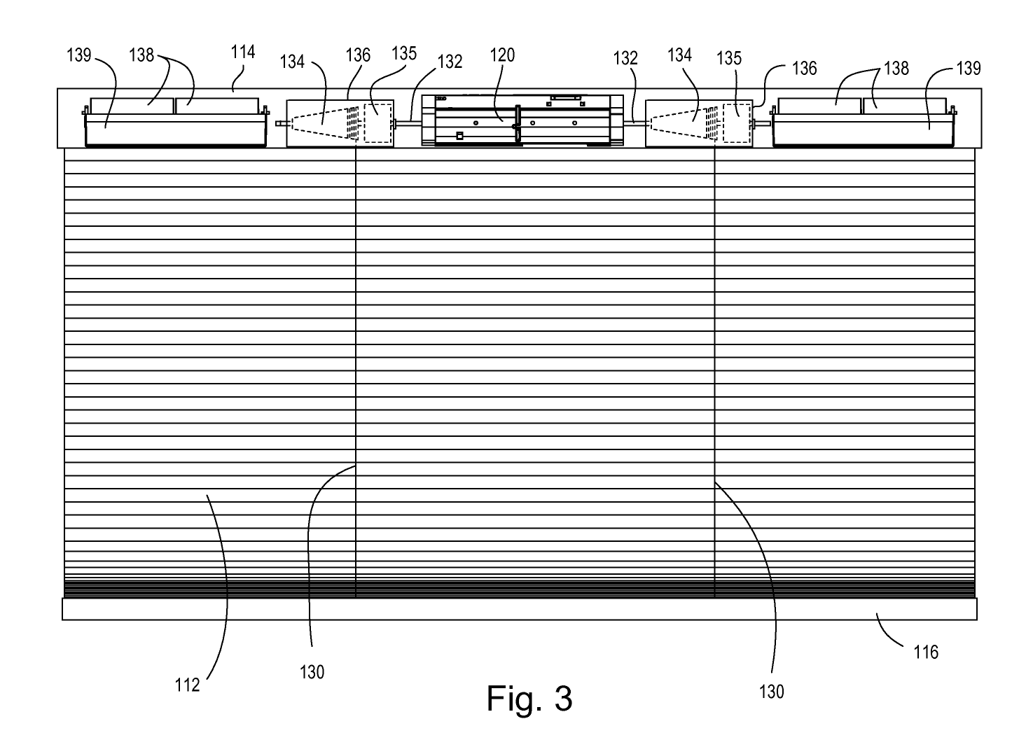

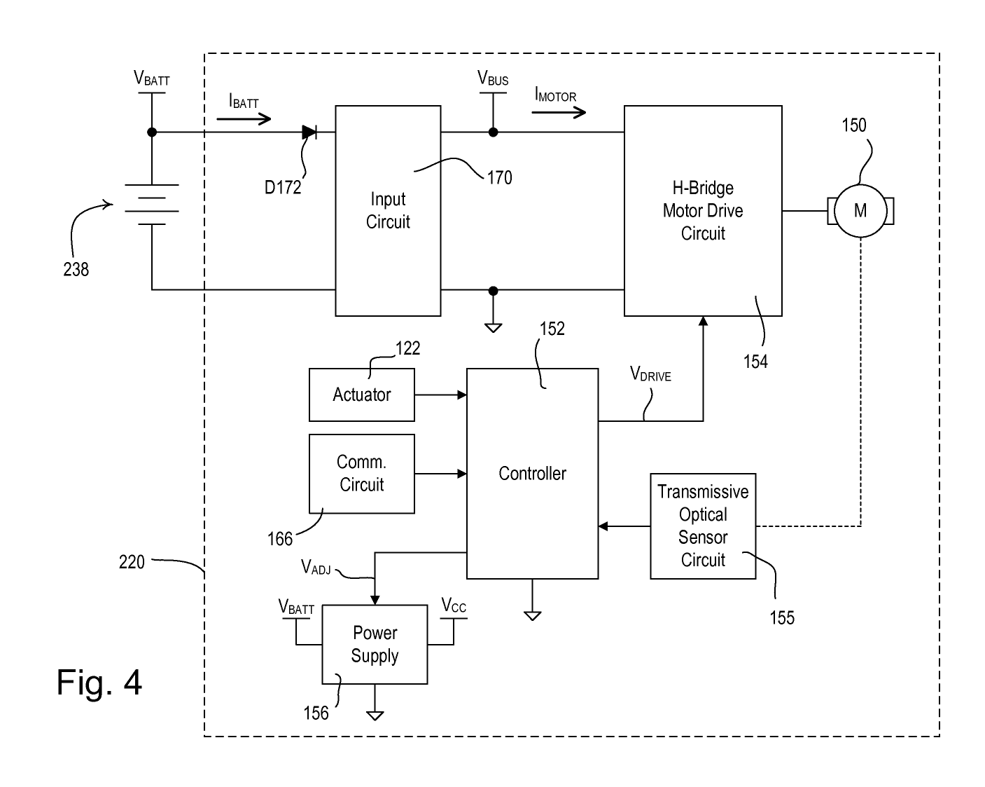

FIG. 3 is a front view of the battery-powered motorized window treatment 110 with a front portion of the headrail 114 removed to show the motor drive unit 120, which is located in the center of the headrail. The motorized window treatment 110 comprises lift cords 130 that extend from the headrail 114 to the weighting element 116 for allowing the motor drive unit 120 to raise and lower the weighting element. The motor drive unit 120 includes an internal motor (e.g., motor 150 shown in FIG. 4) coupled to drive shafts 132 that extend from the motor on each side of the motor and are each coupled to a respective lift cord spool 134. The lift cords 130 are windingly received around the lift cord spools 134 and are fixedly attached to the weighting element 116, such that the motor drive unit 120 is operable to rotate the drive shafts 132 to raise and lower the weighting element. The motorized window treatment 110 further comprises two constant-force spring assist assemblies 135, which are each coupled to the drive shafts 132 adjacent to one of the two lift cord spools 134. Each of the lift cord spools 134 and the adjacent constant-force spring assist assembly 135 are housed in a respective lift cord spool enclosure 136 as shown in FIG. 3. Alternatively, the motorized window treatment 110 could comprise a single drive shaft that extends along the length of the headrail and is coupled to both of the lift cord spools 134 and the motor drive unit 120 could be located in the center of the headrail 114 in the space between the drive shaft and either the internal side 122 or the external side 124 of the headrail. Further, the motorized window treatment 110 could comprise a single drive and the motor drive unit 120 could alternatively be located at either end of the headrail 114.

The battery-powered motorized window treatment 110 also comprises a plurality of batteries 138 (e.g., four D-cell batteries), which are electrically coupled in series. The series-combination of the batteries 138 is coupled to the motor drive unit 120 for powering the motor drive unit. The batteries 138 are housed inside the headrail 114 and thus out of view of a user of the motorized window treatment 110. Specifically, the batteries 138 are mounted in two battery holders 139 located inside the headrail 114, such that there are two batteries in each battery holder as shown in FIG. 2. Since the motor drive unit 120 is located in the center of the headrail 114 and the drive shafts 132 extend out of both sides of the motor drive unit to the lift cord spools 134, there is plenty of the room for the batteries 138 to be located adjacent the opposite sides of the headrail as shown in FIG. 3. The batteries 138 provide the motorized window treatment 110 with a practical lifetime (e.g., approximately three years), and are typical “off-the-shelf” batteries that are easy and not expensive to replace. Alternatively, the motor drive unit 120 could comprise more batteries (e.g., six or eight) coupled in series or batteries of a different kind (e.g., AA batteries) coupled in series. The battery-powered motorized window treatment 110 is described in greater detail in commonly-assigned U.S. Pat. No. 13/415,084, filed Mar. 8, 2012, entitled MOTORIZED WINDOW TREATMENT, the entire disclosure of which is hereby incorporated by reference.

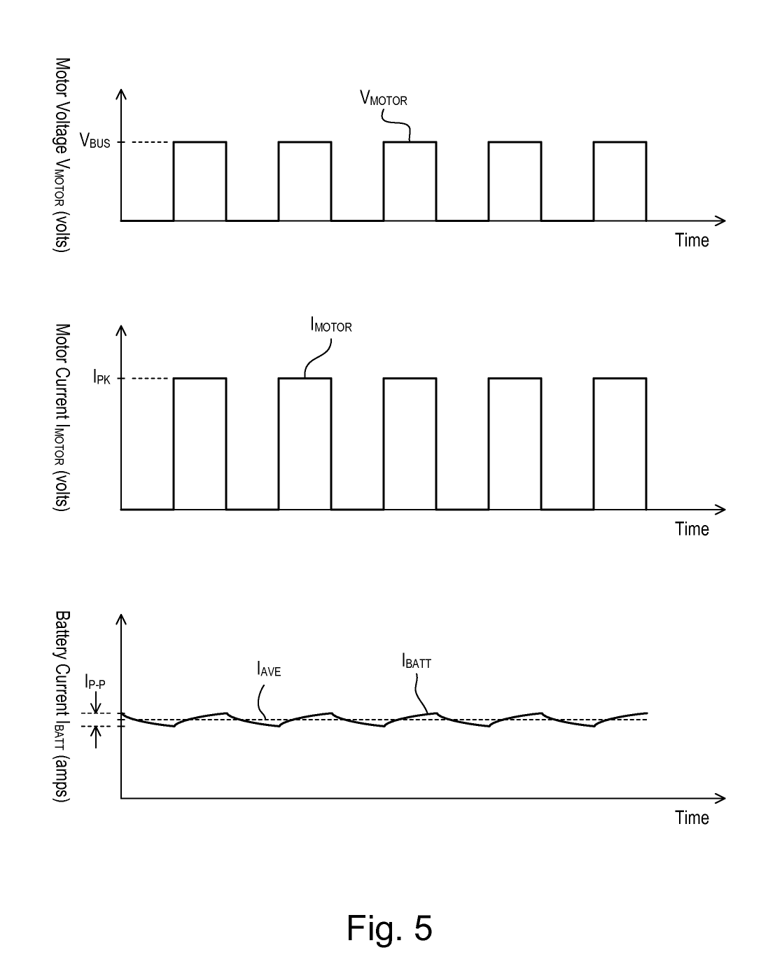

FIG. 4 is a simplified block diagram of a motor drive unit 220 for a battery-powered motorized window treatment (e.g., the motor drive unit 120 of the battery-powered motorized window treatment 110 shown in FIGS. 1-3). FIG. 5 shows example waveforms illustrating the operation of the motorized drive unit 220. As shown in FIG. 4, the motor drive unit 220 comprises a controller 152 for controlling the operation of the motor 150, which may comprise, for example, a DC motor. The controller 152 may comprise, for example, a microprocessor, a programmable logic device (PLD), a microcontroller, an application specific integrated circuit (ASIC), a field-programmable gate array (FPGA), or any suitable processing device or control circuit.

The motorized window treatment 110 further comprises a load control circuit, e.g., an H-bridge motor drive circuit 154, for driving the motor 150. The controller 152 is coupled to the H-bridge motor drive circuit 154 and generates a set of drive signals V_{DRIVE} for driving the motor 150 to adjust the position of the weighting element 116 and the cellular shade fabric 112 between the fully-open position P_{FULLY-OPEN} and the fully-closed position P_{FULLY-CLOSED}. As previously mentioned, the motor drive unit 220 receives power from a battery 238 (which may be the series-coupled batteries 138 of the motorized window treatment 110 of FIG. 1), which provides a battery voltage V_{BATT}. For example, the battery 238 may comprise four series-coupled D-cell batteries 138 having rated voltages of approximately 1.5 volts, such that the battery voltage V_{BATT} has a magnitude of approximately 6 volts.

The H-bridge motor drive circuit 154 receives a bus voltage V_{BUS} and generates a motor voltage V_{MOTOR} across the motor 150 to rotate the motor in response to the drive signals V_{DRIVE} received from the controller 152. The controller 152 is operable to pulse-width modulate the motor voltage V_{MOTOR} to rotate the motor 150 at a constant rotational speed by controlling the H-bridge motor drive circuit 154 to supply a pulse-width modulated (PWM) signal to the motor, such that the motor draws a pulse-width modulated motor current I_{MOTOR} current (i.e., a load current) as shown in FIG. 5. The controller 152 is operable to pulse-width modulate the motor voltage V_{MOTOR} at a constant frequency (e.g., approximately 20 kHz) and a variable duty cycle (e.g., approximately 25-50%). The controller 152 is able to change the rotational speed of the motor 150 by adjusting the duty cycle of the PWM signal applied to the motor and to change the direction of rotation of the motor by changing the polarity of the PWM drive signal applied to the motor. The motor current I_{MOTOR} has a peak magnitude I_{PK}, which may be equal to approximately 3 amps when the controller 152 is driving the motor at a maximum output torque (e.g., when the duty cycle of the motor voltage V_{MOTOR} is approximately 50%).

The motorized window treatment comprises an input circuit coupled between the battery 238 (e.g., the series-coupled batteries 138) and the H-bridge motor drive circuit 154. The input circuit 170 receives the battery voltage V_{BATT} from the batteries 138 through a diode D172 and provides the bus voltage V_{BUS} to the H-bridge motor drive circuit 154. The magnitude of the bus voltage V_{BUS} may be approximately equal to the magnitude of the battery voltage V_{BATT}, i.e., approximately 6 volts. The input circuit 138 operates to draw a battery current I_{BATT} from the batteries 138, where the battery current I_{BATT} has a substantially DC magnitude (as shown in FIG. 5) even though the H-bridge motor drive circuit 154 is conducting the pulse-width modulated motor current I_{MOTOR}. The battery current I_{BATT} is characterized by an average current I_{AVE} and may have a small amount of ripple. For example, the magnitude of the average current I_{AVE} of the battery current I_{BATT} may be approximately one amp when the controller 152 is driving the motor at a maximum output torque (i.e., when the duty cycle of the motor voltage V_{MOTOR} is approximately 50%). The average current I_{AVE} has a peak-to-peak magnitude V_{P-P} less than or equal to, for example, approximately 100 milliamps. The diode D172 operates to prevent the battery current I_{BATT} from having a negative magnitude, for example, reverse current conducted through the batteries 138, which can cause battery leakage.

The controller 152 receives information regarding the rotational position and direction of rotation of the motor 150 from a rotational position sensor, such as, for example, a transmissive optical sensor circuit 155. The rotational position sensor may also comprise other suitable position sensors or sensor arrangements, such as, for example, Hall-effect, optical, or resistive sensors. The controller 152 is operable to determine a rotational position of the motor 150 in response to the transmissive optical sensor circuit 155, and to use the rotational position of the motor to determine a present position P_{PRES} of the weighting element 116. The controller 152 may comprise an internal non-volatile memory (or alternatively, an external memory coupled to the controller) for storage of the present position P_{PRES} of the shade fabric 112, the fully open position P_{FULLY-OPEN}, and the fully closed position P_{FULLY-CLOSED}. The operation of the H-bridge motor drive circuit 154 and the use of sensor devices to track the direction and speed of the motor drive unit 220 is described in greater detail in commonly-assigned U.S. Pat. No. 5,848,634, issued Dec. 15, 1998, entitled MOTORIZED WINDOW SHADE SYSTEM, and commonly-assigned U.S. Pat. No. 6,497,267, issued Dec. 24, 2002, entitled MOTORIZED WINDOW SHADE WITH ULTRAQUIET MOTOR DRIVE AND ESD PROTECTION, the entire disclosures of which are herein incorporated by reference.

A user of the window treatment system 100 is able to adjust the position of the weighting element 116 and the cellular shade fabric 112 by using a remote control (e.g., the RF remote control 190 shown in FIG. 1) to transmit commands to the motor drive unit 220 via wireless signals (e.g., the RF signals 106). The motor drive unit 220 comprises a communication circuit 166, e.g., a wireless communication circuit, such as an RF receiver coupled to an antenna (e.g., a wire antenna that extends from the motor drive unit) for receiving the RF signals 106. The communication circuit 166 is operable to provide an RF data control signal representative of the received RF signals 106 to a controller 152, such that the controller is operable to control the H-bridge motor drive circuit 154 in response to the received signals. An RF receiver is described in greater detail in commonly-assigned U.S. patent application Ser. No. 13/415,537, filed Mar. 8, 2012, entitled LOW-POWER RADIO-FREQUENCY RECEIVER, the entire disclosure of which is hereby incorporated by reference. In addition to receiving RF signals 106 from the remote control 190, the motorized window treatment 110 may be operable to receive signals from other input devices, for example, occupancy sensors, vacancy sensors, daylight sensors, temperature sensors, humidity sensors, security sensors, proximity sensors, keypads, key fobs, cell phones, smart phones, tablets, personal digital assistants, personal computers, timeclocks, audio-visual controls, safety devices, or central control transmitters. Alternatively, the communication circuit 166 could comprise an RF transmitter for transmitting RF signals, an RF transceiver for both transmitting and receiving RF signals, an infrared (IR) receiver for receiving IR signals from an IR remote control, an IR transmitting for transmitting IR signals, or a wired communication circuit.

The motor drive unit 220 further comprises a power supply 156 (e.g., a linear regulator) that receives the battery voltage V_{BATT} and generates a DC supply voltage V_{CC} for powering the controller 152 and other low-voltage circuitry of the motor drive unit. The controller 152 is coupled to the power supply 156 and generates a voltage adjustment control signal V_{ADJ} for adjusting the magnitude of the DC supply voltage V_{CC} between a first nominal magnitude (e.g., approximately 2.7 volts) and a second increased magnitude (e.g., approximately 3.3 volts). The power supply 156 may comprise, for example, an adjustable linear regulator having one or more feedback resistors that are switched in and out of the circuit by the controller 152 to adjust the magnitude of the DC supply voltage V_{CC}. The controller 152 may adjust the magnitude of the DC supply voltage V_{CC} to the second increased magnitude while the controller is driving the motor drive circuit 154 to rotate the motor 150 (since the controller may require an increased supply voltage to drive the motor drive circuit). The controller 152 adjusts the magnitude of the DC supply voltage V_{CC} to the first nominal magnitude when the controller is not controlling the motor drive circuit 154 to rotate the motor 150 (e.g., when the controller is in the sleep mode). The magnitude of the idle currents drawn by the controller 152, the RF receiver 166, and other low-voltage circuitry of the motor drive unit 220 may be significantly smaller when these circuits are powered by the first nominal magnitude of the DC supply voltage V_{CC}.

The controller 152 is operable to determine that the magnitude of the battery voltage V_{BATT} is getting low and to operate in a low-battery mode when the magnitude of the battery voltage V_{BATT} drops below a first predetermined battery-voltage threshold V_{B-TH1} (e.g., approximately 1.0 volts per battery). For example, the controller 152 may control the motor drive circuit 154 so that the motor 150 is operated at a reduced speed (e.g., at half speed) to conserve battery power when the controller 152 is operating in the low-battery mode. This would also serve as an indication to a consumer that the battery voltage V_{BATT} is low and the batteries 138 need to be changed. The controller 152 may also shut down electrical loads in the motor drive unit 220 (e.g., by disabling the RF receiver 166 and other low-voltage circuitry of the motor drive unit) and prevent movements of the cellular shade fabric 112 except to allow for at least one additional movement of the cellular shade fabric to the fully-open position P_{FULLY-OPEN} when in the low-battery mode. The controller 152 may further be operable to shut itself down such that no other circuits in the motor drive unit 220 consume any power in order to protect against any potential leakage of the batteries 138 when in the low-battery mode.

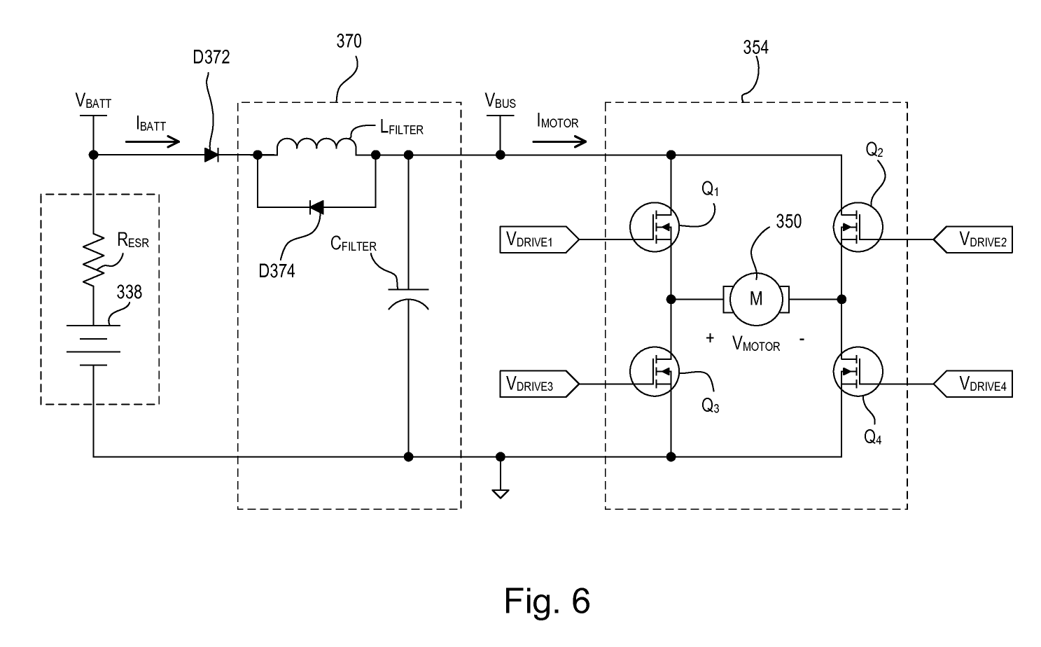

FIG. 6 is a simplified schematic diagram of a portion of a motor drive unit, e.g., the motor drive unit 220 of FIG. 5, shown in greater detail. FIG. 6 shows an input circuit 370 and an H-bridge motor drive circuit 354, which may be the same as the input circuit 170 and the H-bridge motor drive circuit 154 of the motor drive unit 220, respectively. As shown in FIG. 6, a battery 338 (e.g., the series-coupled batteries 138) is characterized by a total equivalent series resistance R_{ESR} that is connected in series with the series-combination of the batteries. For example, each of the series-coupled batteries 138 may have an individual equivalent series resistance of approximately 0.25Ω to 0.40Ω, such that the total equivalent series resistance R_{ESR} may be approximately 1.5Ω to 2.4Ω when there are six batteries. The battery 338 is coupled to the input circuit 370 through a diode D372 (which may operate the same as the diode D172).

The H-bridge motor drive circuit 354 may be operable to drive a motor 350 (e.g., the motor 150 of the motor drive unit 220 of FIG. 5). The H-bridge motor drive circuit 354 may comprise four transistors, such as, for example, four field-effect transistors (FETs) Q₁, Q₂, Q₃, Q₄. Each FET Q₁-Q₄ may be driven by a controller (e.g., the controller 152 of the motor drive unit 220 shown in FIG. 5) via four respective drives signals V_{DRIVE1}, V_{DRIVE2}, V_{DRIVE3}, V_{DRIVE4}. The FETs Q₁-Q₄ are coupled such that, when two of the FETs are conductive (e.g., FETs Q₁, Q₄), the motor voltage V_{MOTOR} has a positive magnitude to cause the motor 350 to rotate in a clockwise direction. When the other two FETs of the H-bridge circuit 354 are conductive (e.g., FETs Q₂, Q₃), the motor voltage V_{MOTOR} has a negative magnitude to cause the motor 350 to rotate in the reverse (i.e., counter-clockwise) direction. To control the speed of the motor 350, the controller 352 drives at least one of FETs of the H-bridge circuit 354 with a PWM control signal. When the motor 350 is idle (i.e., at rest), the controller 152 drives only the FET Q₁ to be conductive and controls FETs Q₂, Q₃, Q₄ to be non-conductive.

The input circuit 370 may comprise a passive filter circuit, for example, having an inductor L_{FILTER} and a capacitor C_{FILTER} (i.e., an LC filter). The inductor L_{FILTER} and the capacitor C_{FILTER} form an RLC circuit with the total equivalent series resistance R_{ESR} of the battery 338. For example, the inductor L_{FILTER} may have an inductance of approximately 22 μH and the capacitor C_{FILTER} may have a capacitance of approximately 220 μF, such that the input circuit 370 may be characterized by a cutoff frequency of approximately 2.3 kHz. The input circuit 370 may further comprise a diode D374 coupled in parallel with the inductor L_{FILTER} for preventing an inductive voltage spike when the current through the inductor (e.g., the battery current I_{BATT}) drops to zero amps. Accordingly, the battery current I_{BATT} drawn from the batteries 138 has a substantially DC magnitude even though the motor current I_{MOTOR} conducted through the output of the input circuit 370 is pulse-width modulated.

Alternatively, the input circuit 370 may comprise an active circuit (such as a power converter, e.g., a boost converter) that is operable to operate in a continuous conduction mode, such that the battery current I_{BATT} conducted through the battery 338 has substantially no ripple (e.g., less than approximately 100 milliamps).

While the present invention has been described with reference to the battery-powered motorized window treatment 110 having an H-bridge motor drive circuit 154, 354 for driving the motor 150, 350, the input circuit 170, 370 of the present invention could be used in other battery-powered load control devices for controlling other types of electrical loads via pulse-width modulated signals, such as, lighting control circuits for controlling lighting loads, for example, battery-powered light-emitting diode (LED) drivers for LED light sources.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A battery-powered control device for controlling an electrical load, the control device comprising:
at least one battery for generating a battery voltage;
a load control circuit coupled to the electrical load for conducting a pulse-width modulated load current through the electrical load; and
an input circuit coupled between the battery and the load control circuit and having an output for conducting the pulse-width modulated load current;
wherein the input circuit is operable to conduct a substantially DC battery current from the battery.

2. The battery-powered control device of claim 1, wherein the input circuit comprises a filter circuit.

3. The battery-powered control device of claim 2, wherein the filter circuit comprises an inductor coupled in series between the battery and the load control circuit, and a capacitor coupled between circuit common and the junction of the inductor and the load control circuit.

4. The battery-powered control device of claim 3, wherein a bus voltage produced across the capacitor is provided to the load control circuit.

5. The battery-powered control device of claim 4, wherein the magnitude of the bus voltage is approximately equal to the magnitude of the battery voltage.

6. The battery-powered control device of claim 2, wherein the filter circuit comprises an LC filter.

7. The battery-powered control device of claim 1, wherein the input circuit comprises an active circuit.

8. The battery-powered control device of claim 7, wherein the input circuit comprises a power converter.

9. The battery-powered control device of claim 8, wherein the power converter comprises a boost converter.

10. The battery-powered control device of claim 1, wherein the electrical load comprises a motor, and the load control circuit comprises an H-bridge drive circuit.

11. The battery-powered control device of claim 10, wherein the battery-powered control device comprises a battery-powered motorized window treatment.

12. The battery-powered control device of claim 10, further comprising:
a controller operatively to the H-bridge drive circuit for driving the motor with a pulse-width modulated signal, the controller operable to adjust the duty cycle of the pulse-width modulated signal to adjust the rotational speed of the motor.

13. The battery-powered control device of claim 1, wherein the electrical load comprises a lighting load, and the load control circuit comprises a lighting control circuit.

14. The battery-powered control device of claim 13, wherein the lighting load comprises an LED light source, and the lighting control circuit comprises an LED driver.

15. The battery-powered control device of claim 1, wherein the substantially DC battery current conducted through the battery has a peak-to-peak magnitude less than approximately 100 milliamps.

16. A battery-powered motorized window treatment comprising:
at least one battery for generating a battery voltage;
a motor;
an H-bridge drive circuit coupled to the motor for driving the motor;
a controller operatively coupled to the H-bridge drive circuit for driving the motor with a pulse-width modulated signal, such that the H-bridge drive circuit conducts a pulse-width modulated load current through the motor, the controller operable to adjust the duty cycle of the pulse-width modulated signal to adjust the rotational speed of the motor; and
an input circuit coupled between the battery and the H-bridge drive circuit and having an output for conducting the pulse-width modulated load current;
wherein the input circuit is operable to conduct a substantially DC battery current from the battery.

17. The motorized window treatment of claim 16, wherein the input circuit comprises a passive filter circuit.

18. The motorized window treatment of claim 17, wherein the filter circuit comprises an inductor coupled in series between the battery and the H-bridge drive circuit, and a capacitor coupled between the junction of the inductor and the H-bridge drive circuit and circuit common.

19. The motorized window treatment of claim 18, wherein a bus voltage produced across the capacitor is provided to the H-bridge drive circuit for driving the motor.

20. The motorized window treatment of claim 19, wherein the magnitude of the bus voltage is approximately equal to the magnitude of the battery voltage.

21. The motorized window treatment of claim 16, further comprising:
a covering material;
wherein rotations of the motor result in movements of the covering material.

22. The motorized window treatment of claim 21, further comprising:
at least one drive shaft rotatably coupled to the motor and operatively coupled to the covering material, such that rotations of the motor result in movements of the covering material.

23. The motorized window treatment of claim 21, further comprising:
a roller tube rotatably coupled to the motor, the covering material windingly received around the roller tube, such that rotations of the motor result in movements of the covering material.

24. The motorized window treatment of claim 16, wherein the input circuit comprises an active circuit.

25. A battery-powered motorized window treatment comprising:
a covering material;
a motor;
an H-bridge drive circuit coupled to the motor for driving the motor;
a controller operatively coupled to the H-bridge drive circuit for driving the motor with a pulse-width modulated signal, such that the H-bridge drive circuit conducts a pulse-width modulated load current through the motor, the controller operable to adjust the duty cycle of the pulse-width modulated signal to adjust the rotational speed of the motor;
at least one battery for generating a battery voltage; and
a filter circuit coupled between the battery and the H-bridge drive circuit and having an output for conducting the pulse-width modulated load current;
wherein the filter circuit is operable to conduct a substantially DC battery current from the battery.

26. The motorized window treatment of claim 25, wherein the filter circuit comprises an inductor coupled in series between the battery and the H-bridge drive circuit, and a capacitor coupled between the junction of the inductor and the H-bridge drive circuit and circuit common.

27. The motorized window treatment of claim 26, wherein a bus voltage produced across the capacitor is provided to the H-bridge drive circuit for driving the motor.

28. The motorized window treatment of claim 27, wherein the magnitude of the bus voltage is approximately equal to the magnitude of the battery voltage.

29. The motorized window treatment of claim 25, further comprising:
at least one drive shaft rotatably coupled to the motor and operatively coupled to the covering material, such that rotations of the motor result in movements of the covering material.

30. The motorized window treatment of claim 25, further comprising:
a roller tube rotatably coupled to the motor, the covering material windingly received around the roller tube, such that rotations of the motor result in movements of the covering material.
